(19) United States
(12) Patent Application Publication
(10) Pub. No.: US 2008/0197655 A1
(43) Pub. Date: Aug. 21, 2008

(54) Blind Assembly For a Motor Vehicle

(75) Inventors: Philipp Oerke, Munchen (DE); Andreas Rockelmann, Munchen (DE); Sebastian Glasl, Munchen (DE)

Correspondence Address: MARSHALL, GERSTEIN & BORUN LLP, 233 S. WACKER DRIVE, SUITE 6300, SEARS TOWER, CHICAGO, IL, 60606, US

(73) Assignee: Webasto AG, Stockdorf (DE)

(21) Appl. No.: 11/994,281

(22) PCT Filed: Jun. 28, 2006
(86) PCT No.: PCT/DE2006/001114

§ 371 Date: Mar. 3, 2008

(30) Foreign Application Priority Data
Jun. 30, 2005 (DE) 102005030973.9

(51) Int. Cl. B60J 1/20

(52) U.S. Cl. 296/83

(57) ABSTRACT

A blind assembly for a motor vehicle, comprising a blind web that is extensible or movable in a longitudinal direction, and two guides that run in the longitudinal direction of the blind web and are located at a distance from each other in a transverse direction of the blind web. The blind web can be guided between the guides. The blind assembly further comprises expanding means which are part of the blind web or are connected thereto. The expanding means can be expanded at least in the transverse direction of the blind web or allow the blind web to be stretched in the transverse direction. The expanding means are provided with at least two components. At least one first component is elastic in the transverse direction of the blind web while at least one second component is non-elastic in the transverse direction of the blind web.

The present invention relates to a blind assembly for a motor vehicle according to the preamble of claim 1.

Blind assemblies of the abovementioned type can be used, for example as sun blinds, in a motor vehicle. In particular, it is possible for the blind web to be able to wound up at one of its longitudinal ends onto a winding shaft. As an alternative to this, it is also conceivable for the blind web not to be able to be wound up but rather to be able to be displaced as a whole in the longitudinal direction. With blind assemblies of this type, there is the possibility that the guides are at a distance from each other which differs, albeit only minimally, over their longitudinal extent, the distance being, for example, the result of manufacturing tolerances. Said possibly differing distance is generally compensated for by the selection of a flexible material for the blind web. However, under some circumstances, the manufacturer is restricted as a result in the optical configuration of the blind web.

A blind assembly of the type mentioned at the beginning is known from German Laid Open Specification DE 100 19 787 A1. In the case of the blind assembly described therein, a non-rigid fabric is used as the blind web. The lateral guides are designed as C-shaped guide rails in which sliding bodies are secured in a movable manner in order to guide the blind web. In the transverse direction of the blind web, an elastic element is provided in each case between the blind web and the sliding bodies, said element permitting adaptation of the assembly comprising blind web, elastic element and sliding bodies to distances between the guides that, under some circumstances, change in the longitudinal direction of the blind web. Furthermore, in a blind assembly of this type, the blind web as such does not have to be elastic in the transverse direction, and therefore the optical configuration of the blind web can be selected comparatively freely because of the material used.

A further blind assembly of the type mentioned at the beginning is known from German Laid Open Specification DE 103 06 951 A1. In the case of the blind assembly described therein, the blind web as such can be composed of two different materials, namely of an elastic material and an inelastic material. This results in similar properties as in the first-mentioned Laid Open Specification.

The problem on which the present invention is based is the provision of a blind assembly of the type mentioned at the beginning, which is configured more effectively and/or more simply.

This is achieved according to the invention by a blind assembly of the type mentioned at the beginning with the characterizing features of one of claims 1, 3, 4, 7, 11 or 12. The subclaims relate to preferred developments of the invention.

According to claim 1, it is provided that the expanding means are composed of plastic or comprise plastic. This selection of material affords diverse possibilities of designing the expanding means.

For example, it may be provided that, on at least one of its sides facing the guides, the blind web is connected, at least in some sections, to the expanding means.

According to claim 3, it is provided that the blind web has, in the transverse direction, two segments which are spaced apart from each other at least in some sections, and that the expanding means are arranged at least in some sections between the two segments. As a result, the blind web can be provided with an interruption, for example an elastic interruption, at any desired location. The connection of the blind web to the guides is not impaired here by the presence of the expanding means.

According to claim 4, it is provided that the expanding means have at least two components, of which at least one first component is elastic in the transverse direction of the blind web and at least one second component is inelastic in the transverse direction of the blind web. This results in additional configuration possibilities in the design of the expanding elements.

In particular, it may be provided in this case that the at least one first component has a smaller thickness than the at least one second component. Such a design can be produced in a simple manner and can nevertheless contribute effectively to the expansion in the transverse direction.

For example, it may be provided in this case that the at least one second component forms at least one guide element or, at least in some sections, is part of at least one guide element which interacts with one of the guides for guiding the blind web. It is therefore possible to use very simple means to provide a unit which serves as a guide element and ensures the expansion in the transverse direction.

According to claim 7, it is provided that the expanding means comprise a seam which is connected to the blind web and is expandable in the transverse direction of the blind web. Such a seam can be realized in a simple manner and can nevertheless contribute effectively to the expansion in the transverse direction or can even entirely bring about said expansion.

For example, it may be provided in this case that those sections of the blind web which form the seam and of a part which is connected to the blind web via the seam are spaced apart from one another. This spaced-apart arrangement enlarges the seam region in the transverse direction, and therefore it is also possible for the expandability in the transverse direction to be increased.

As an alternative or in addition, it may be provided in this case that the seam comprises an elastic thread. The selection of an elastic thread constitutes a simple realization of an elastic seam.

It may also be provided here that the part which is connected to the blind web via the seam forms at least one guide element or, at least in some sections, is part of at least one guide element which interacts with one of the guides for guiding the blind web.

According to claim 11, it is provided that the expanding means comprise at least one elastic part which overlaps the blind web in the transverse direction and is connected to the blind web in the overlapping region. By means of a corresponding expansion of the overlap, the expandability in the transverse direction can be increased.

According to claim 12, it is provided that the expanding means are realized by a blind web which is flexible in the longitudinal direction or is fastened flexibly to at least one tension element surrounded by the blind assembly and which compensates for an expansion in the transverse direction by a compression, at least in some sections, in the longitudinal direction. The expanding means can also be realized in a comparatively simple manner by such a configuration.

For example, it may be provided in this case that the at least one tension element is designed as a tension bow which interacts with the guides and is preferably bendable elastically or in the longitudinal direction. Despite being able to be realized cost-effectively, such a tension bow can contribute effectively to the expansion in the transverse direction or can bring about said expansion.

As an alternative or in addition, it may be provided in this case that the connection between blind web and tension bow has a certain amount of play, at least in a region which is spaced apart from the guides. The expansion in the transverse direction can also be brought about or reinforced as a result using simple means.

It may furthermore be provided that the tension bow comprises a flexible element about which the blind web is at least partially guided, and therefore, by deformation of the flexible element or moving the flexible element into the tension bow, that section of the blind web which surrounds the flexible element can be shortened. The expansion in the transverse direction can also be brought about or reinforced as a result using simple means.

In particular, the flexible element in this case may be designed as an elastic hollow profile. By means of such a hollow profile composed, for example, of rubber, a shortening of that section of the blind web which surrounds the tension bow can be made possible using simple means.

As an alternative or in addition, it may be provided that the tension bow is rotatable about its longitudinal axis and that the blind web is guided at least partially about the tension bow, and therefore, by rotation of the tension bow, that section of the blind web which surrounds the blind web can be shortened. The expansion in the transverse direction can also be brought about or reinforced as a result.

There is furthermore the possibility that the tension bow is secured via pivotable retaining elements such that it is moveable in the longitudinal direction of the blind web. Such a configuration can also bring about or reinforce the expansion in the transverse direction.

As an alternative or in addition, it may be provided that a piping which is bendable in the longitudinal direction is attached to the blind web at the end thereof which is arranged in the region of the tension bow. Like an elastic tension bow, such a piping can contribute effectively to the expansion in the transverse direction or can bring about said expansion despite being able to be realized cost-effectively.

Further features and advantages of the present invention become clear with reference to the description below of preferred exemplary embodiments and with reference to the attached figures, in which

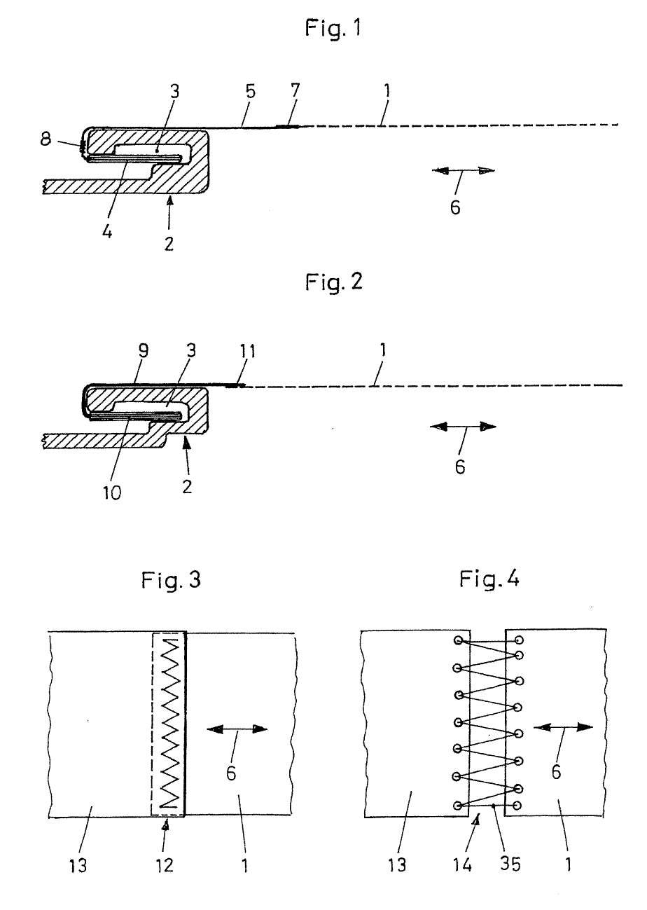

FIG. 1 shows a schematic sectional view of a first embodiment of a blind assembly according to the invention;

FIG. 2 shows a schematic sectional view of a second embodiment of a blind assembly according to the invention;

FIG. 3 shows a plan view of a seam of a blind assembly according to the invention;

FIG. 4 shows a plan view of a further embodiment of a seam of a blind assembly according to the invention;

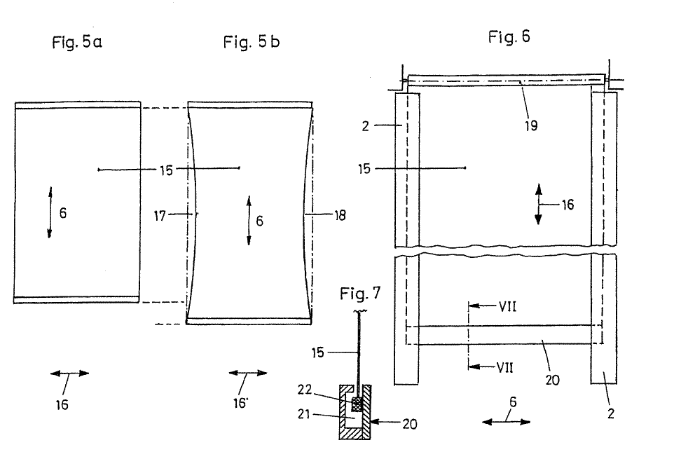

FIG. 5a shows a plan view of a section of a blind web according to the invention;

FIG. 5b shows a plan view of the section according to FIG. 5a upon expansion in the transverse direction;

FIG. 6 shows a schematic plan view of a further embodiment of a blind assembly according to the invention;

FIG. 7 shows a section according to the arrows VII-VII in FIG. 6;

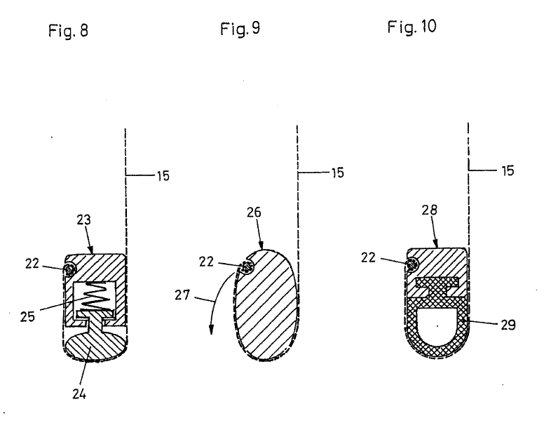

FIG. 8 shows a section corresponding to FIG. 7 through a further embodiment of a tension bow of a blind assembly according to the invention;

FIG. 9 shows a section corresponding to FIG. 7 through a further embodiment of a tension bow of a blind assembly according to the invention;

FIG. 10 shows a section corresponding to FIG. 7 through a further embodiment of a tension bow of a blind assembly according to the invention;

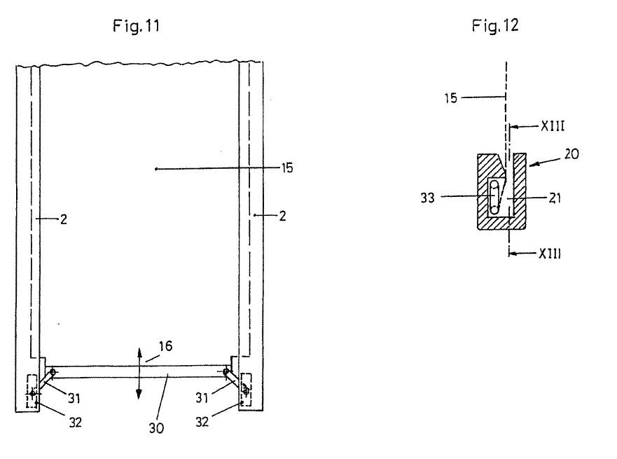

FIG. 11 shows a schematic plan view of a further embodiment of a blind assembly according to the invention;

FIG. 12 shows a section corresponding to FIG. 7 through a further embodiment of a tension bow of a blind assembly according to the invention;

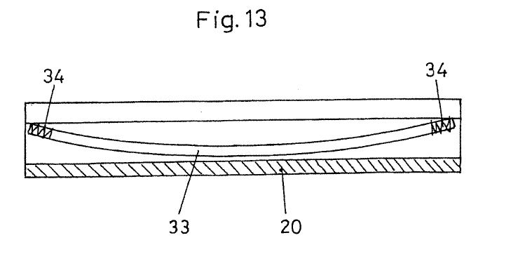

FIG. 13 shows a section according to the arrows XIII-XIII in FIG. 12.

The embodiment of a blind assembly according to the invention that can be seen in FIG. 1 comprises a blind web 1 which can be composed, for example, of a non-rigid textile material. The blind assembly shown in FIG. 1 furthermore comprises two guides 2, of which only one is shown in FIG. 1. In the exemplary embodiment shown, the guides 2 are designed as C-profiles within the widest meaning and have a recess 3 into which a guide element 4 can project. The blind web 1 is connected to the guide element 4 via a part 5 which may be part of the expanding means. In the transverse direction 6 of the blind web 1 (see arrow with the reference number 6), the blind web 1 is therefore adjoined on each side by parts 5 which, at their end facing away from the blind web 1, are each connected to a guide element 4 which projects into a corresponding recess 3 of the respective guide 2. By this means, the blind web 1 can be moved in the longitudinal direction of the vehicle (into or out of the plane of the drawing of FIG. 1) between the guides 2.

There is the possibility of the part 5 being of elastic design, for example in the form of a rubber band or similar part. As an alternative or in addition to this, there is the possibility of the connecting point between the part 5 and the blind web 1 being of elastic design. FIG. 1 shows a seam 7 which connects the part 5 to the blind web 1. Said seam 7 may be of elastic design in the transverse direction 6 of the blind web 1. As an alternative or in addition to this, there is the possibility of the connection between part 5 and guide element 4 likewise being of elastic design, in particular likewise as seam 8.

There is the possibility of part 5, which can be seen in FIG. 1 and, in particular, is elastic, not being provided on the outer edges of the blind web 1 in the transverse direction 6 but rather, for example, of dividing the blind web 1 in the transverse direction into two segments which are separated from each other and between which an elastic part, such as, for example, the elastic part 5, extends. An elasticity of expansion in the transverse direction 6 is thereby also achieved without the actual fabric of the blind web 1 having to be elastic in expansion in the transverse direction.

In the embodiment of a blind assembly according to the invention that can be seen in FIG. 2, identical parts are provided with the same reference numbers as in FIG. 1.

The blind web 1 is connected in this case on its outer side in the transverse direction to an extending means comprising two components 9, 10. The two-component expanding means may be a plastic part. In this case, the component 9 which directly adjoins the blind web 1 is elastic in the transverse direction 6 of the blind web 1 whereas the second component 10 which adjoins the first component 9 is comparatively hard or inelastic in the transverse direction 6 of the blind web 1. In the exemplary embodiment shown, said second component 10 is designed in such a manner that it serves as a guide element which can engage in the recess 3 of the guide 2.

It can be gathered from FIG. 2 that the thickness of the first component 9 is significantly smaller than the thickness of the second component 10. The effect which can thereby be achieved, when the same material is used for the first component 9 and the second component 10, is that the first component 9 is elastic in tension in the transverse direction 6 whereas the second component 10 has as good as no elasticity of tension because of its material thickness.

There is also the possibility in the exemplary embodiment shown in FIG. 2 to fasten the two-component expanding means to the blind web 1 via a connection designed as a seam 11. Nevertheless, of course, other possibilities of connection between the blind web 1 and the expanding means, such as, for example, adhesive connections or the like, are also possible.

A seam 12 via which the blind web 1 is connected to a further part 13 in the transverse direction 6 of the blind web 1 can be seen in detail in FIG. 3. Owing to the fact that the seam 12 as such is elastic in the transverse direction 6, the part 13 does not have to be elastic in order to permit elasticity of the expansion in the transverse direction 6 of the blind web 1. For example, the part 13 may be part of a guide element. Of course, there is also the possibility of the part 13 being an elastic part in the transverse direction 6, such as, for example, the first component 9 according to FIG. 2, or an elastic part, such as the part 5 according to FIG. 1.

The elasticity of the seam 12 can be brought about by the seam structure as such. There is also the possibility of using elastic yarns to produce the seam 12. As an alternative or in addition to this, there is also the possibility of using both an elastic seam structure and elastic yarns. In the case of the seam 12 shown in FIG. 3, the blind web 1 and the part 13 connected thereto in the transverse direction 6 overlap in the region of the seam.

In the case of the alternative seam 14, shown in FIG. 4, between the blind web 1 and the part 13, the blind web 1 and the part 13 are spaced apart from each other in the transverse direction 6. A thread 35 of the seam 14 thereby extends between the two mutually facing ends of the blind web 1 and of the part 13. The elasticity of expansion of the blind assembly in the transverse direction 6 is ensured by the variable distance between the blind web 1 and the part 13. In particular, an elastic seam structure or an elastic thread 35 may also be used here. There is also the possibility of tensioning the thread 35 between the part 13 and the blind web 1 only after the blind web 1 is fitted into the blind assembly, in order to thereby obtain an optimum seam 14.

A further possibility for obtaining or reinforcing the elasticity of expansion in the transverse direction of the blind web 1 resides in a corresponding configuration of the connection between blind web 1 and, for example, the part 5 in FIG. 1. The elasticity of expansion can be brought about or increased in particular by an overlapping of blind web 1 and part 5 or part 13, which can also be seen in FIG. 2 and in FIG. 3. In this case, in particular the part 5, 13 which is connected to the blind web 1 via the overlap can be elastic. In the overlapped region, as can be seen, for example in FIG. 2 or FIG. 3, the blind web 1 can be connected to the part 5, 13 via a seam or via adhesive.

The blind web 15 which can be seen in FIG. 5a and 5b is configured in such a manner that it makes expansion in the transverse direction 6 (vertical direction in FIG. 5a and FIG. 5b) possible by means of a compression in the longitudinal direction 16 (see corresponding arrow in FIG. 5b). This compression in the longitudinal direction 16 is indicated in FIG. 5b by constrictions 17, 18 on the longitudinal ends of the blind web 15.

FIG. 6 shows an exemplary embodiment of a blind assembly according to the invention, in which the property, which is clarified in FIG. 5a and FIG. 5b, of the fabric of the blind web 15 is used. FIG. 6 shows the blind web 15 which extends in the transverse direction 6 between the two guides 2. On the right side of the blind web 15 in the longitudinal direction 16, a winding shaft 19, onto which the blind web 15 can be wound, is indicated schematically. A tension bow 20 which extends in the transverse direction 6 of the blind web 15 is arranged on that side of the blind web 15 which faces away from the winding shaft 19. The tension bow 20 engages here by means of its ends on the transverse-direction side in the guides 2 or in the recesses 3 (not shown in FIG. 6) of the guides 2.

In order to make compression of the blind web 15 in the longitudinal direction 16 possible, it is possible, for example, for the tension bow 20 to be bendable in the longitudinal direction 16. As an alternative to this, there is also the possibility of the blind web 15 being connected to the tension bow 20 in a virtually floating manner. FIG. 7 shows an example of a connection possibility between the blind web 15 and the tension bow 20. In this case, the tension bow 20 has a recess 21 for the engagement of a piping 22 which is attached to that end of the blind web 15 which is at the bottom in FIG. 6. The recess 21 is larger, in particular in the longitudinal direction 16, than the piping 22, and therefore the latter can move in the longitudinal direction 16 in the tension bow 20. By this means, in particular given a flexurally elastic design of the piping 22, the blind web 15 can be compressed in the longitudinal direction 16 in order to make expansion in the transverse direction 6 possible. Under some circumstances, the piping 22 may also be prestressed in the longitudinal direction 16 in the recess 21.

FIG. 8 shows a tension bow 23 in which the piping 22 is accommodated in a recess on the left side of the tension bow 23 in FIG. 8. The blind web 15 extends from the piping 22 about the left, the lower and the right side of the tension bow 23 in FIG. 8. A flexible element 24 is arranged on the lower side of the tension bow 23 in FIG. 8, which element can be pressed somewhat further into the tension bow 23 on account of a spring 25 provided in the tension bow 23. The pressing of the flexible element 24 into the tension bow 23 shortens the travel of the blind web 15 about the tension bow, thus resulting in the compression, which is necessary for the transverse expansion, in the longitudinal direction 16.

As an alternative, there is also the possibility of arranging the flexible element 24 on the left or the right side of the tension bow 23. The only thing of importance is that the flexible element can yield upon tightening of the blind web 15, for example by means of a movement into the tension bow 23.

FIG. 9 shows a tension bow 26 which is rotatable in the counterclockwise direction or in the direction of the arrow 27 in FIG. 9. Also in this embodiment, the piping 22 is arranged in a recess on the left side of the tension bow 26, with the blind web 15 also extending here from the recess in the counterclockwise direction or in the direction of the arrow 27 about the tension bow 26 as far as the right side thereof in FIG. 9. By the tension bow 26 being rotatable in the direction of the arrow 27, the blind web 15 can likewise be shortened or compressed in the longitudinal direction 16 upon transverse expansion.

FIG. 10 shows a tension bow 28 which has a flexible element designed as an elastic hollow profile 29. It may be, for example, a hollow profile 29 which is composed of rubber. Also in this embodiment, the piping 22 is arranged in a, for example, lateral or upper or lower recess, with the blind web 15 extending from said recess about the hollow profile 29. On account of the deformability of the hollow profile 29, the blind web 15 can likewise be shortened or compressed in the longitudinal direction 16, thus making expansion in the transverse direction 6 possible.

FIG. 11 shows a blind assembly in which the tension bow 30 is connected via pivotable retaining elements 31 to guide elements 32 for guiding the tension bow 30 in the guides 2. If a shortening or compression of the blind web 15 in the longitudinal direction is necessary, this can be achieved by pivoting of those ends of the retaining elements 31 which are on the tension-bow side upward in FIG. 11.

An exemplary embodiment of a flexurally elastic piping 33 can be seen in FIG. 12 and FIG. 13. The piping 33 is prestressed in this case by means of fixing elements 34, and therefore the central region of the piping 33, which region is spaced apart from the guides 2, is spaced apart from the winding shaft 19 further in the longitudinal direction 16 than that region of the piping 33 which is adjacent to the guides 2. In this case, a compression of the blind web 15 in the longitudinal direction 16 can take place by means of a movement of the central region in the longitudinal direction 16 toward the winding shaft 19.

### LIST OF REFERENCE NUMBERS

1, 15 Blind web

2 Guide

3 Recess in 2

4 Guide element

5 Part connected to the blind web 1

6 Transverse direction of the blind web 1, 15

7, 8, 11, 12, 14 Seam

9 First component

10 Second component

13 Part connected to the blind web 1

16 Longitudinal direction of the blind web 1, 15

17, 18 Constrictions of the blind web 1,15

19 Winding shaft

20, 23, 26, 28, 30 Tension bow

21 Recess in 20

22, 33 Piping

24 Flexible element

25 Spring

27 Direction of rotation

29 Elastic hollow profile

31 Pivotable retaining elements

32 Guide element

34 Fixing element

35 Thread

1. A blind assembly for a motor vehicle, comprising
a blind web which is extensible or movable in a longitudinal direction;
two guides which extend in the longitudinal direction of the blind web and are spaced apart from each other in a transverse direction of the blind web, wherein the blind web can be guided between the guides;
expanding means which are part of the blind web or are connected to the blind web, wherein the expanding means can be expanded at least in the transverse direction of the blind web or permit an expansion of the blind web in the transverse direction;
wherein the expanding means comprise plastic.

2. The blind assembly as claimed in claim 1, wherein, on at least one of its sides facing the guides, the blind web is connected, at least in some sections, to the expanding means.

3. The blind assembly as claimed in claim 1, wherein the blind web has, in the transverse direction, two segments which are spaced apart from each other at least in some sections, and in that the expanding means are arranged at least in some sections between the two segments.

4. The blind assembly as claimed in claim 1, wherein the expanding means have at least two components, of which at least one first component is elastic in the transverse direction of the blind web and at least one second component is inelastic in the transverse direction of the blind web.

5. The blind assembly as claimed in claim 4, wherein the at least one first component has a smaller thickness than the at least one second component.

6. The blind assembly as claimed in claim 4, wherein the at least one second component forms at least one guide element or, at least in some sections, is part of at least one guide element which interacts with one of the guides for guiding the blind web.

7. The blind assembly as claimed in claim 1, wherein the expanding means comprise a seam which is connected to the blind web and is expandable in the transverse direction of the blind web.

8. The blind assembly as claimed in claim 7, wherein those sections of the blind web which form the seam and of a part which is connected to the blind web via the seam are spaced apart from one another.

9. The blind assembly as claimed in claim 7, wherein the seam comprises an elastic thread.

10. The blind assembly as claimed in claim 8, wherein the part which is connected to the blind web via the seam forms at least one guide element or, at least in some sections, is part of at least one guide element which interacts with one of the guides for guiding the blind web.

11. The blind assembly as claimed in claim 1, wherein the expanding means comprise at least one elastic part which overlaps the blind web in the transverse direction and is connected to the blind web in the overlapping region.

12. The blind assembly as claimed in claim 1, wherein the expanding means are realized by a blind web which is flexible in the longitudinal direction or is fastened flexibly to at least one tension element surrounded by the blind assembly and which compensates for an expansion in the transverse direction by a compression, at least in some sections, in the longitudinal direction.

13. The blind assembly as claimed in claim 12, wherein the at least one tension element is designed as a tension bow which interacts with the guides and is preferably bendable elastically or in the longitudinal direction.

14. The blind assembly as claimed in claim 13, wherein the connection between the blind web and tension bow has a certain amount of play, at least in a region which is spaced apart from the guides.

15. The blind assembly as claimed in claim 13, wherein the tension bow comprises a flexible element about which the blind web is at least partially guided, and therefore, by deformation of the flexible element or moving the flexible element into the tension bow, that section of the blind web which surrounds the flexible element can be shortened.

16. The blind assembly as claimed in claim 15, wherein the flexible element is designed as an elastic hollow profile.

17. The blind assembly as claimed in claim 13, wherein the tension bow is rotatable about a longitudinal axis, and the blind web is guided at least partially about the tension bow, and therefore, by rotation of the tension bow, that section of the blind web which surrounds the blind web can be shortened.

18. The blind assembly as claimed in claim 13, wherein the tension bow is secured via pivotable retaining elements such that it is movable in the longitudinal direction of the blind web.

19. The blind assembly as claimed in claim 13, wherein a piping which is bendable in the longitudinal direction is attached to the blind web at the end thereof which is arranged in the region of the tension bow.
